(19) United States
(12) Patent Application Publication
(10) Pub. No.: US 2014/0237870 A1
(43) Pub. Date: Aug. 28, 2014

(54) LICENSE PLATE FRAME HAVING AN INTEGRATED HANDLE AND MOUNTING STUDS

(71) Applicant: Thomas Eidsmore, Santa Cruz, CA (US)

(72) Inventor: Thomas Eidsmore, Santa Cruz, CA (US)

(21) Appl. No.: 14/232,799

(22) PCT Filed: Jul. 16, 2012
(86) PCT No.: PCT/US12/46854

§ 371 Date: May 9, 2014

Related U.S. Application Data
(60) Provisional application No. 61/507,856, filed on Jul. 14, 2011.

(51) Int. Cl. B60R 13/10

(52) U.S. Cl. CPC B60R 13/105; G09F 2007/1895
USPC 40/209

(57) ABSTRACT

A license plate frame is dimensioned for receipt around an associated license plate. The frame includes a first portion in parallel, spaced relation from a second portion and joined thereto along opposite ends by first and second interconnection portions. A handle extends outwardly from a first face of the second portion. First and second spaced openings along the first portion receive associated fasteners to secure the frame to the associate license plate and associated vehicle. First and second spaced apart, segmented studs (circular or non-circular) extend outwardly from a second face of the second portion for receipt in corresponding openings in the associated license plate, or to abut against an outer surface thereof. The handle includes a first, upper surface and a second, lower surface, the lower surface including a region dimensioned for advertising.

### BACKGROUND

This disclosure is directed to a license plate frame and more particularly, a license plate frame that includes mounting studs that cooperate with mounting openings in an associated license plate. In one aspect, the license plate frame includes an integrated handle for use as a rear license plate frame and to facilitate lifting and closing of a trunk or deck lid of an automotive vehicle.

It is well known in the art to provide a frame for a license plate, typically an open-centered frame that is intended to cover a limited, peripheral region of the license plate. The license plate frame includes one or more openings dimensioned to receive a fastener, such as a screw, for securing the license plate frame to the license plate and the associated automotive vehicle. Advertising or a decorative appliqué is oftentimes applied to the surface of the license plate frame so that it can be viewed in the same plane as the license plate.

When used simply for decorative or advertising purposes, the license plate frame does not require much structural strength or rigidity. Typically, such a conventional license plate frame is formed from a thin, inexpensive plastic material.

Commonly owned US D516,483 discloses a version of a license plate frame that includes an integrated handle. The handle is preferably located along a lower region of the generally annular frame and extends substantially perpendicularly outward a limited distance from the outer, planar external surface of the frame. When mounted to the sedan-type automotive vehicle, i.e. where the license plate is mounted to the rear trunk or deck lid, the handle provides an alternative means for lifting and closing the trunk lid relative to the vehicle. This prevents the vehicle user from leaving undesired smudge, or fingerprints, dirt, surface blemishes, etc. on the vehicle, typically along a bent region of the trunk lid.

A need exists to improve the connection of the license plate frame with integrated handle with the license plate. Although four spaced openings are typically provided in each license plate, i.e. two spaced openings along a laterally extending upper portion of the license plate frame, and two openings similarly spaced along a laterally extending lower portion of the license plate frame, automotive vehicle designs may only provide a pair of fasteners for securing the license plate frame and license plate through the upper openings. This leaves the lower openings in the license plate free to move relative to the license plate frame which can lead to an undesired rattle, and more importantly lack of strength and rigidity which is desired when using the integrated handle.

Accordingly, a need exists for an improved arrangement that overcomes these deficiencies and others, while providing an easy means to open and close the trunk lid.

### SUMMARY

A license plate frame dimensioned for receipt around an associated license plate, the frame includes a first portion spaced in parallel relation from a second portion and joined thereto along opposite ends by first and second interconnection portions. An integrated handle extends outwardly from a first face of the second portion. First and second spaced openings are provided along the first portion and dimensioned to receive associated fasteners for securing the license plate frame to an associated license plate and associated automotive vehicle. First and second spaced apart studs extend outwardly from a second face of the second portion.

The first and second studs are segmented and dimensioned so that the studs extend into associated openings in the associated license plate.

The first and second studs each has a segmented circular outer perimeter in one embodiment and the first and second studs each has a segmented, elongated outer perimeter in another embodiment.

The first and second studs may each include a retention member along an outer end for enabling a snap-fit connection with an associated license plate.

The first and second openings in the first portion are substantially circular in one embodiment, and are non-circular in another embodiment.

The handle includes a first, upper surface that may include a recess dimensioned to receive an associated user's fingertips and a second, lower surface, that may include a region dimensioned for advertising.

Each of the first and second studs in one arrangement includes a tapered shoulder to facilitate receipt in an associated opening of the license plate.

The first portion in one embodiment has a generally constant width between the first and second interconnection portions, and in another embodiment the first portion has a central portion with a greater width than end regions.

The second portion in one embodiment has a generally constant width between the first and second interconnection portions, and in another embodiment has a central portion with a greater width than end regions.

One advantage is a license plate frame that does not rattle when installed on the associated license plate and associated automotive vehicle.

Another benefit relates to having integrated fasteners or connectors between the license plate frame and the license plate.

Still another advantage is the provision of an integrated handle.

Yet another benefit is associated with the additional advertising region provided by the integrated handle.

Still other benefits and advantages will become apparent to those skilled in the art upon reading and understanding the following detailed description.

### BRIEF DESCRIPTION OF THE DRAWINGS

FIG. 1 is a front plan view of the license plate frame.

FIG. 2 is a rear plan view thereof.

FIG. 3 is a bottom view thereof.

FIG. 4 is an elevational view taken generally along the right-hand side of FIG. 1.

FIG. 5 is an enlarged view of the encircled region of FIG. 4, shown partly in cross-section.

FIG. 6 is an enlarged view of the encircled region of FIG. 2.

FIG. 7 is an enlarged view of an alternate embodiment of the encircled region of FIG. 4, shown partly cross-section.

FIG. 8 is an enlarged view of the alternate embodiment FIG. 7 and shows the encircled region of FIG. 2.

FIG. 9 is a front plan view of another embodiment of the license plate frame.

FIG. 10 is a rear plan view of the embodiment of FIG. 9.

FIG. 11 is a bottom plan view of the embodiment of FIG. 9.

FIG. 12 is an elevational view taken generally along the right-hand side of FIG. 9.

FIG. 13 is an enlarged view of the encircled region of FIG. 12.

FIG. 14 is an enlarged view of the encircled region of FIG. 10.

FIG. 15 is an enlarged view of an alternate embodiment of the encircled region of FIG. 12.

FIG. 16 is an enlarged view of the alternate embodiment of FIG. 15 and shows the encircled region of FIG. 10.

### DETAILED DESCRIPTION

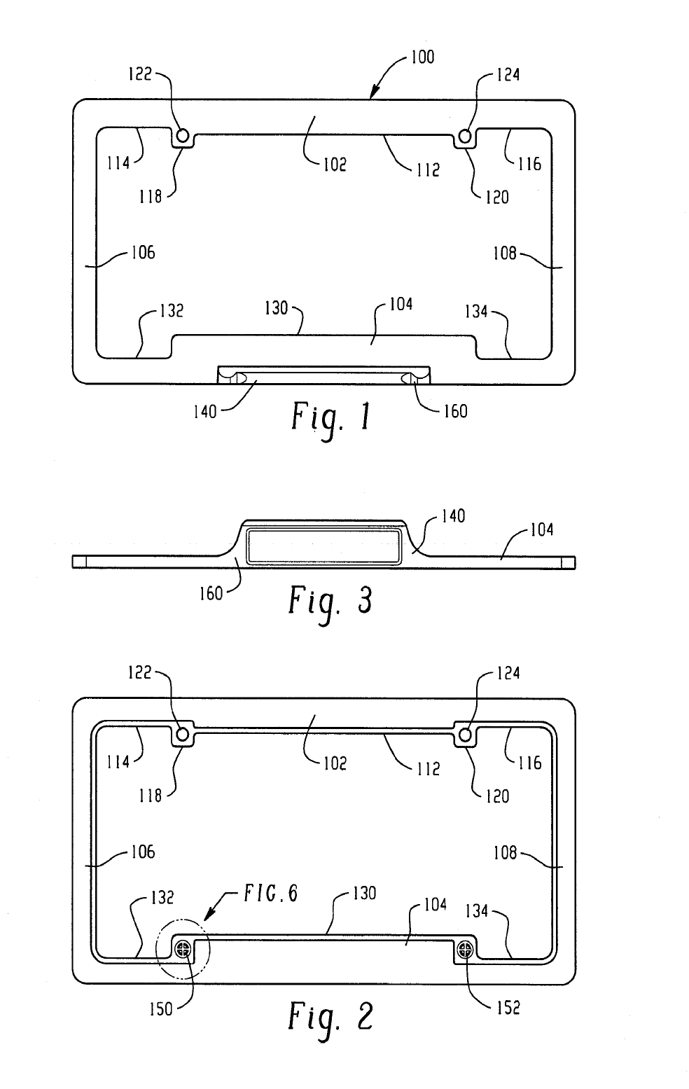

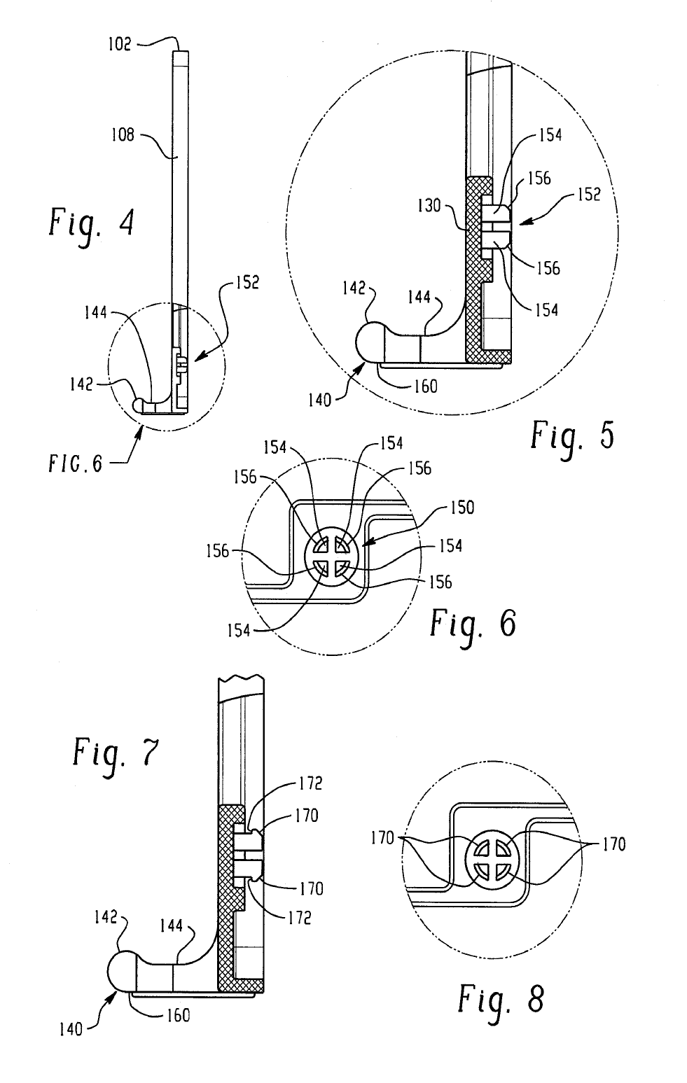

With initial reference to FIGS. 1-6, there is shown a license plate frame 100 having an open-centered, generally annular configuration with a first or upper laterally extending portion 102 and a second or lower laterally extending portion 104. Laterally extending portions 102, 104 are substantially parallel. A third or interconnection portion 106 extends along the left-hand side, while a fourth or interconnection portion 108 extends along the right-hand side of the frame 100. A central region 112 of the laterally extending portion 102 is slightly wider or thicker than end regions 114, 116. Tab 118 is disposed between the central region and end region 114, and in a similar manner tab 120 is interposed between the central region 112 and end region 116. Each tab 118, 120 has an opening 122, 124, respectively. A central region 130 of the lower, laterally extending portion 104 is also wider or thicker than end regions 132, 134. An integrated handle 140 extends substantially perpendicularly outward (FIGS. 4 and 5) from the generally planar, outwardly facing surface of the central region 130, and preferably along a lower perimeter edge thereof. That is, the integrated handle is formed from the same material as the remainder of the license plate frame, i.e., it is a unitary or one-piece construction. The handle has a generally rounded conformation 142 along a distal portion thereof to provide an ergonomic recess 144 having a dimension that receives a user's fingertips and allows outer ends of the fingertips to grippingly engage the recess and rounded portion 142.

As is evident in FIG. 1, the openings 122, 124 in the upper portion are laterally spaced apart. In this preferred arrangement, no openings are provided in the lower portion 104. Rather, expanding, mounting studs 150, 152 are provided in the corner regions of the central portion 130 and extend outwardly from the rear face of the lower portion 104, one of which is encircled in FIG. 2, and also illustrated in greater detail in FIGS. 5 and 6. It will be appreciated that description of one of the studs is equally applicable to the other unless noted otherwise. In the preferred arrangement, each of the studs includes four, quadrant portions 154 (FIG. 6) that project outwardly in generally parallel relation from the rear surface of central region 130. Of course, one skilled in the art will appreciate that the particular number of portions 154 that form each stud 150 or 152 is illustrative only and should not be deemed to limit the present disclosure. A tapered or chamfered shoulder 156 is preferably provided along the distal, outer perimeter edge of each of the stud portions 154. The tapered shoulder serves to guide the stud portions through a respective opening (not shown) of an associated license plate, forcing the quadrant portions to deflect toward one another and, in turn, impose an engaging, friction fit with the inner perimeter of the license plate opening. This arrangement effectively secures the lower portion 104 of the frame 100 to the license plate. It also makes installation easier for users and eliminates the possibility of the user not securing the lower portion 104 of the frame to the license plate. Further, the outer surface of central region 130 remains unblemished and is not adversely impacted since the mounting studs extend rearwardly from the frame. Engraving, advertising, or design provided along this outer surface of the central region 130 has a smoother, more premium aesthetic look. Further, fastening hardware is eliminated for securing the lower portion 104 of the frame to the license plate.

As noted above, the mounting studs 150, 152 extending rearwardly from the lower portion 104 of the frame allows for customization, and provides an unblemished outer surface. In other instances, users prefer a high-quality, chrome plated surface without further ornamentation. Thus this outwardly facing surface of the frame when mounted to the license plate and to the vehicle may be either ornamental or non-ornamental. However, car dealers or other aftermarket suppliers seek to have advertising while still satisfying the user's desire for control of the outwardly facing surface of the frame (i.e., the user wants to determine whether the outwardly facing surface is ornamental or non-ornamental). To accommodate these competing needs, there is provided a more discreet, unobtrusive, and inconspicuous location. More particularly, an underside or lower surface 160 of the frame, and particularly on the lower surface of the handle 140, includes a recessed or indented region 162. The indented region provides a place for a promotional sticker, for example, that is viewable or seen each time that the trunk lid is opened. When the trunk lid is closed, the indented region 162 faces downwardly and is not evident to third parties. For example, a car dealership could advertise a website address, or other data or information such as when the next service or tune-up is due, on the bottom of the handle. In addition, if the license plate frame 100 is provided by the car dealership, the dealer can choose whether or not to provide additional advertising on the outer surface of the license plate frame that is viewable from behind the car when the trunk lid is in a closed position.

FIGS. 7 and 8 are substantially identical to the illustrations in FIGS. 5 and 6 however the expanding mounting studs are modified to include retention members or ears 170 that form a radial shoulder 172 that projects through a lower opening (not shown) in the associated license plate so that the radial shoulder engages a rear surface of the license plate in a snap-fit connection.

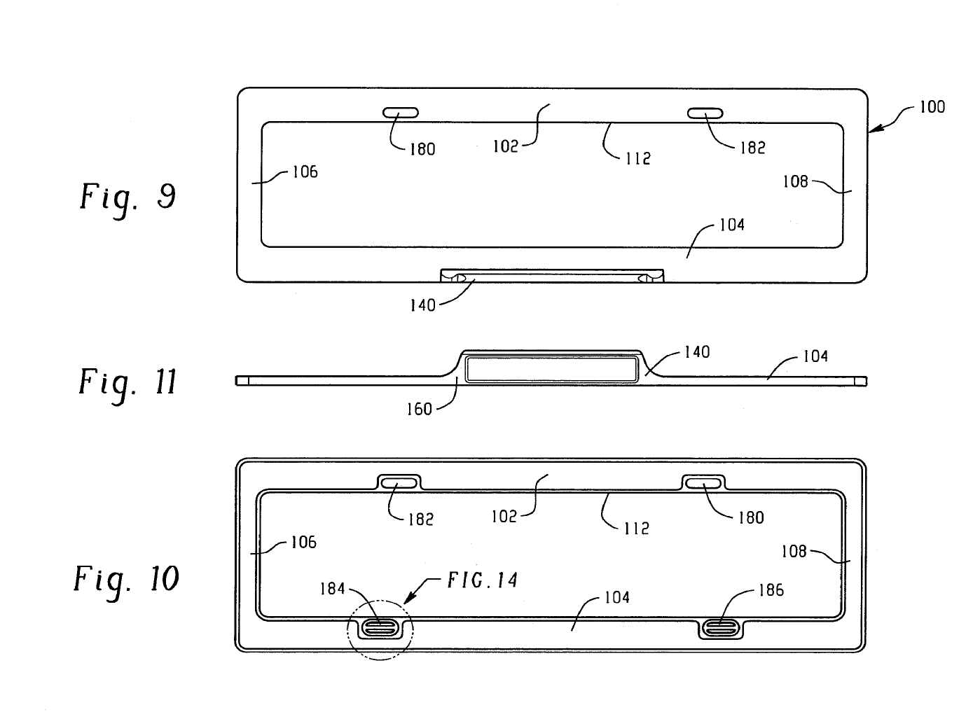

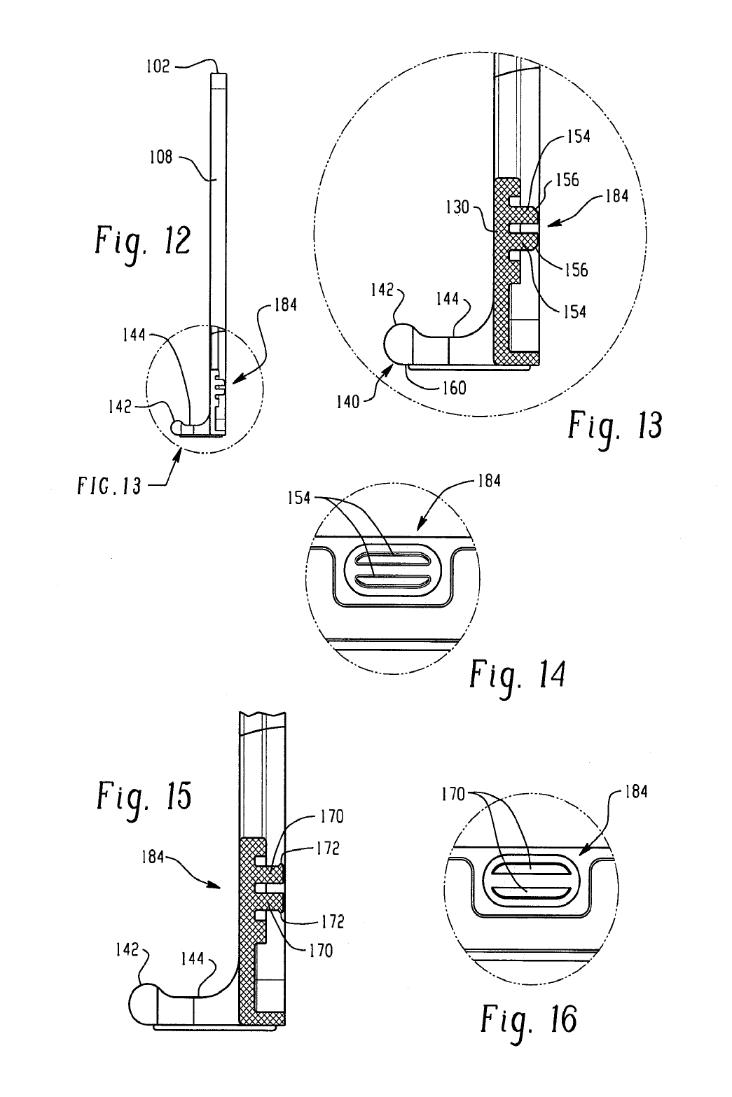

The embodiment of FIGS. 9-14 is also substantially similar to the embodiment of FIGS. 1-6. Therefore, like reference numerals will refer to like elements, and new reference numerals will be used to identify different or modified components. Particularly, whereas openings 122, 124 in FIG. 1 are substantially circular, in the embodiment of FIG. 9, the openings are elongated slots 180, 182. Similarly, the mounting studs 184, 186 that extend outwardly from the rear face of the license plate frame are still segmented, but only two stud portions are shown, and each has a generally elongated conformation that allows the lower portion of the license plate frame to pass through elongated slots or openings in the license plate. Another distinction is that the width of the upper and lower lateral portions is generally constant.

FIGS. 15 and 16 illustrate another modified embodiment in which the shape of the mounting studs are still generally elongated in a manner similar to that of FIGS. 1-9. However, outer ends of the segmented portions that form the mounting studs each preferably include retention members or ears 170 that form a radial shoulder 172 that projects through a lower opening (not shown) in the associated license plate so that the radial shoulder engages a rear surface of the license plate in a snap-fit connection.

Since many vehicles of various makes and models do not have lower fastening openings for mounting the license plate, the use of the mounting or expanding studs to effectively secure the bottom of the license plate frame is provided. The outer surface of the license plate frame can be coated, such as in a high-quality chrome plating. The integrated handle and interconnection of the frame to the license plate on both the upper and lower portions provides for a convenient, ergonomic manner to open and close the trunk lid. The integrated handle keeps dirty hands and jewelry, for example, away from the paint finish of the vehicle. This prevents possible damage to the car and likewise prevents dirtying of the sleeves or hands of the user as would typically be encountered by opening and closing the trunk lid by grabbing the painted surface of the trunk lid. The handle is integrated into the design as low-profile structure that is easy to grasp with a few fingers and by exerting only a fraction of the energy previously exerted without such an integrated handle. The integrated mounting studs also conveniently and effectively secure the frame to the license plate and prevent potential relative movement and associated noise.

The disclosure has been described with reference to the preferred embodiments. Modifications and alterations will occur to others upon reading and understanding the specification. The application is intended to include all such modifications and alterations in so far as they come within the scope of the disclosure with such modifications or any appended claims or their equivalents.

1. A license plate frame dimensioned for receipt around an associated license plate, the frame comprising:
a first portion spaced from a second portion and joined thereto along opposite ends by first and second interconnection portions;
a handle extending outwardly from a first face of the second portion;
first and second spaced openings along the first portion; and
first and second spaced apart studs extending outwardly from a second face of the second portion.

2. The license plate frame of claim 1 wherein the first and second studs are segmented and dimensioned so that the studs extend into associated openings in the associated license plate.

3. The license plate frame of claim 2 wherein the first and second studs each has a segmented circular outer perimeter.

4. The license plate frame of claim 2 wherein the first and second studs each has a segmented, elongated outer perimeter.

5. The license plate frame of claim 4 wherein the first and second studs each includes a retention member along an outer end for enabling a snap-fit connection with an associated license plate.

6. The license plate frame of claim 2 wherein the first and second studs each includes a retention member along an outer end for enabling a snap-fit connection with an associated license plate.

7. The license plate frame of claim 1 wherein the first and second openings in the first portion are substantially circular.

8. The license plate frame of claim 1 wherein the first and second openings in the first portion are non-circular.

9. The license plate frame of claim 1 wherein the handle includes a first, upper surface and a second, lower surface, the lower surface including a region dimensioned for advertising.

10. The license plate frame of claim 1 wherein the handle includes a first, upper surface and a second, lower surface, the upper surface including a recess dimensioned to receive an associated user's fingertips.

11. The license plate frame of claim 1 wherein each of the first and second studs includes a tapered shoulder to facilitate receipt in an associated opening of the license plate.

12. The license plate frame of claim 1 wherein the first portion has a generally constant width between the first and second interconnection portions.

13. The license plate frame of claim 1 wherein the first portion has a central portion with a greater width than end regions.

14. The license plate frame of claim 1 wherein the second portion has a generally constant width between the first and second interconnection portions.

15. The license plate frame of claim 1 wherein the second portion has a central portion with a greater width than end regions.
